(19) United States
(12) Patent Application Publication
(10) Pub. No.: US 2018/0157688 A1
(43) Pub. Date: Jun. 7, 2018

(54) LEDGER-CHAINED DISTRIBUTED INFORMATION HANDLING SYSTEMS AND METHODS

(71) Applicant: Dell Products, LP, Round Rock, TX (US)

(72) Inventors: Steven P. Zessin, Austin, TX (US); Marissa M. Moore, Austin, TX (US)

(21) Appl. No.: 15/368,601

(22) Filed: Dec. 3, 2016

(51) Int. Cl. G06F 17/30; H04L 29/08; H04L 29/06; G06Q 10/10

(52) U.S. Cl. CPC G06F 17/30318; H04L 67/12; G06F 17/30336; G06Q 10/10; H04L 69/22

(57) ABSTRACT

Ledger-chained distributed information handling systems (LCDIHS) and methods are provided. LCDIHS may include M devices and O controllers. Each of M devices may be configured to process inputs using an algorithm from a set of N algorithms configured to process inputs to generate at least one result, and each of O controllers may be configured to process a subset of the algorithms or a subset of the results to generate a ledger entry corresponding to the subset of the N algorithms or the subset of the N results. A method for the LCDIHS may include automatically modifying at least one of the N algorithms to generate a modified algorithm comprising at least one of a modified code or at least one modified input for the at least one of the N algorithms. The method may further include providing the modified algorithm to a subset of the O controllers.

### TECHNICAL FIELD

The present disclosure relates to information handling systems and methods, and in certain examples to ledger-chained distributed information handling systems and methods.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems often include middleware devices and distributed hosts configured to provide computing or storage resources to users of the information handling systems. Middleware devices may provide intelligence and analytics services closer to the users of the information handling systems. As an example, a middleware device may provide useful results by processing inputs and providing the results to certain users. Because of changes in the relative significance of the inputs or other factors, the results provided by such middleware devices may become stale or otherwise sub-optimal over time.

### SUMMARY

In one example, the present disclosure relates to an information handling system (IHS) including M augmented sensors, where M is a positive integer, and where each of the M augmented sensors is configured to process at least a plurality of inputs using at least one algorithm from a set of N algorithms, wherein N is a positive integer, and wherein each of the N algorithms is configured to process a plurality of inputs to generate at least one result. The IHS may further include O controllers, where O is a positive integer, and where each of the O controllers is configured to process at least one of a subset of the N algorithms or a subset of at least N results to generate at least one entry for a ledger comprising at least one header and at least one ledger value corresponding to the at least one of the subset of the N algorithms or the subset of the at least N results, where each of the M augmented sensors is further configured to without any direct input from any of L hosts, wherein L is a positive integer, and where each of the L hosts is configured to provide at least one service to the IHS, automatically modify at least one of the N algorithms to generate a modified algorithm, where the modified algorithm comprises at least one of a modified code for the least one of the N algorithms or at least one modified input for the at least one of the N algorithms, and where each of a subset of the O controllers is further configured to, based on at least the modified algorithm, automatically generate at least one modified header and at least one modified ledger value for at least one ledger entry.

In another aspect, the present disclosure relates to a method in an information handling system (IHS) comprising: (1) M devices, where M is a positive integer, and where each of the M devices is configured to process at least a plurality of inputs using at least one algorithm from a set of N algorithms, where N is a positive integer, and where each of the N algorithms is configured to process a plurality of inputs to generate at least one result, and (2) O controllers, where O is a positive integer, and where each of the O controllers is configured to process at least one of a subset of the N algorithms or a subset of at least N results to generate at least one header and at least one ledger value for at least one ledger entry corresponding to the at least one of the subset of the N algorithms or the subset of the at least N results. The method may include, without any direct input from any of L hosts, where L is a positive integer, and where each of the L hosts is configured to provide at least one service to the IHS, automatically modifying at least one of the N algorithms to generate a modified algorithm, where the modified algorithm comprises at least one of a modified code for the least one of the N algorithms or at least one modified input for the at least one of the N algorithms. The method may further include providing the modified algorithm to a subset of the O controllers.

In yet another aspect, the present disclosure relates to an information handling system (IHS) including M devices, where M is a positive integer, and where each of the M devices is configured to process at least a plurality of inputs using at least one algorithm from a set of N algorithms, where N is a positive integer, and where each of the N algorithms is configured to process a plurality of inputs to generate at least one result. The IHS may further include O controllers, where O is a positive integer, and where each of the O controllers is configured to generate at least one entry for a ledger comprising at least one header and at least one ledger value corresponding to the at least one of the subset of the N algorithms or the subset of the at least N results, where each of the M devices is further configured to automatically modify at least one of the N algorithms to generate a modified algorithm, where the modified algorithm comprises at least one of a modified code for the at least one of the N algorithms or at least one modified input for the at least one of the N algorithms, and where each of a subset of the O controllers is further configured to, based on at least the modified algorithm, automatically generate at least one modified header and at least one modified ledger value for at least one ledger entry.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The present disclosure is illustrated by way of example and is not limited by the accompanying figures, in which like references indicate similar elements. Elements in the figures are illustrated for simplicity and clarity and have not necessarily been drawn to scale.

FIG. 1 is a block diagram of a ledger-chained distributed information handling system in accordance with one example;

FIG. 2 is a block diagram of a controller for a ledger-chained distributed information handling system in accordance with one example;

FIG. 3 is a diagram illustrating a portion of a ledger-chained distributed information handling system in accordance with one example;

FIG. 4 is a diagram illustrating a device for use in a distributed information handling system in accordance with one example;

FIG. 5 is a diagram illustrating a method in a ledger-chained distributed information handling system in accordance with another example; and

FIG. 6 is a diagram illustrating a method in a ledger-chained distributed information handling system in accordance with another example.

### DETAILED DESCRIPTION

Examples described in this disclosure relate to ledger-chained distributed information handling systems and methods for such ledger-chained distributed information handling systems. For purposes of this disclosure, an information handling system may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

There has been exponential growth in the amount of real-time data and the analysis of such real-time data. As an example, the explosion of data streams and influx of changed data from areas such as smart devices, consumer electronics, automobiles, traffic signals, GPS, geospatial data, smart grids, people, animals, air, water, supply chains and any other devices or data that is involved in production, distribution and consumption affects the outcomes of more events. In such a distributed environment of data overload and data changes, the complexity of events that lead to other even more complicated events is unavoidable. In one example, this disclosure relates to managing such a distributed environment by placing more capable middleware devices or sensors between a gateway/node and pure lightweight (read-only) sensors on the edge of the distributed environment. In this example, the middleware sensors may be small yet powerful, e.g., single-chip modules or small form-factor multi-chip modules. Such middleware devices or sensors may use in-memory database solutions (for example, hybrid DRAM/addressable flash systems) to enable real-time analytics and situational awareness of live transaction data rather than rely on after the fact analysis on stale centralized nodes. The relevant data analysis near the edge may rely heavily on the software/firmware algorithm(s) provided initially in the middleware devices. Unpredictability in data trends, however, can lead to an antiquated data analysis algorithm. In this scenario, the data must traverse another step closer to the data-center for it to be properly analyzed, which can introduce latency and stale results. As an example, an algorithm that analyzes worldwide economic trends and feeds the results back into another algorithm that impacts stock market trading may become stale as trends change or other market conditions change. Delinquent analysis of one algorithm may greatly impact the results of another algorithm. To ameliorate such problems, the present disclosure provides various embodiments for managing algorithm changes and then distributing the changes to the algorithms and the live transaction results to the other devices/sensors in a decentralized manner.

Certain examples of the present disclosure relate to ledger-chained distributed information handling systems. In distributed information handling systems, devices closer to an edge of the system, for example, middleware devices in a cloud computing system or augmented sensors in an Internet-of-Things (IoT) system, may process various inputs and generate results for consumption by other devices or users. In certain examples, such devices may be middleware devices for analyzing various inputs, including for example telemetry inputs. In other examples, such devices may be augmented sensors that may not only sense inputs or receive inputs, but also process the inputs based on certain algorithms to generate results. In this example, there may be a request to include a new data variable or a continuous transaction result, perhaps from another node, gateway, or cloud network, into an existing algorithm already running from the memory of a middleware device. Substantially real-time data may be fed back from one or many nodes/gateways/clouds to the relevant middleware device(s) indicating that the middleware device(s) algorithm is not returning optimal results or is not considering other relevant input variables. A modification to the existing algorithm may either be determined programmatically (self-determined) or manually by a human. The new replacement code may be generated for modifying the algorithm. The replacement code may be applied to the relevant middleware device memory by an agent/application. The change to the algorithm or an encrypted value corresponding to the change may be stored in a ledger-chain mechanism, such as a blockchain. Next, the new algorithm may be evaluated using the same metrics that triggered the change to the original algorithm. If the change is deemed acceptable, it may remain in the device's memory. If the change is determined to produce unacceptable results, it may simply be removed from the device's memory; the old algorithm may be restored; and the blockchain may be updated. Thus, in this example, the feedback mechanism to trigger an algorithm change may be autonomous and managed using ledger-chaining. By automating the distribution and management of algorithms run by middleware devices, the present disclosure may advantageously reduce the overhead associated with large distributed systems and may advantageously make the results more correct and less stale. Algorithm changes may be applied at the object code level instead of the full application binary image. This allows the algorithm updates to be performed without having to restart the device or the specific system software component after the image in memory has been updated. It may also advantageously allow for the tweak to be removed without disruption to the system, if necessary.

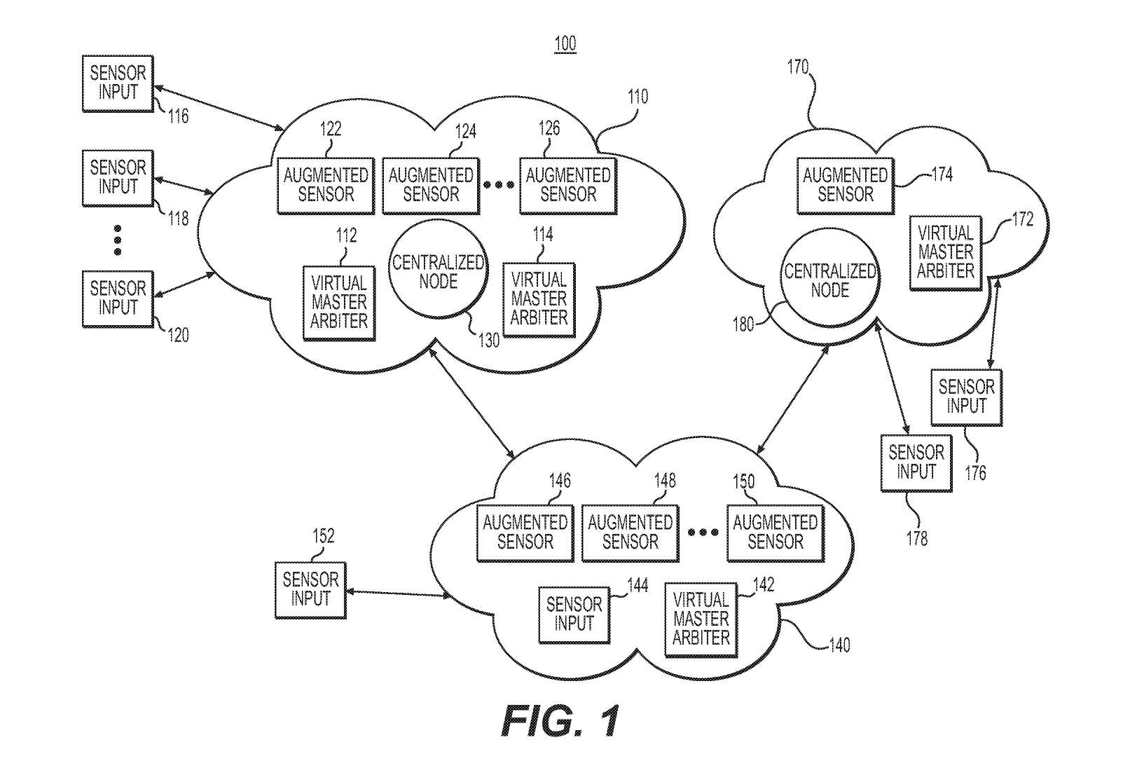

FIG. 1 is a block diagram of a ledger-chained distributed information handling system (LCDIHS) 100 in accordance with one example. LCDIHS 100 may include a cloud compute network 110 coupled to a gateway 140 which further may be coupled to a sensor network 170. Cloud compute network 110 may include various types of devices, sensors, controllers, and host or centralized nodes. These devices, sensors, controllers, and nodes may be interconnected using a network such as a wired network, a wireless network, or a combination of these. The network may also be a private network, such as a private cloud-computing network. The network may be implemented using Ethernet, FDDI, or other types of networking technologies. Communication among the various components may occur using unicast transmissions, broadcast transmissions, or multicast transmissions. Ethernet Layer 2 and/or Layer 3 functionality may be used to enable multicast transmissions and broadcast transmissions. Broadcast and multicast operations may be implemented based on User Datagram Protocol (UDP) in a TCP/IP based system. Unicast operations may be implemented based on Transport Control Module (TCP) in a TCP/IP based system.

With continued referenced to FIG. 1, as an example, cloud compute network 110 may include augmented sensor 122, augmented sensor 124, and augmented sensor 126. Compute cloud network 110 may further include a virtual master arbiter 112 and another virtual master arbiter 114. Compute cloud network 110 may further include a centralized node 130. Augmented sensors, for example augmented sensor 122, may receive sensor inputs such as sensor input 116, sensor input 118, or sensor input 120. In general, any of the augmented sensors may receive any of the sensor inputs in any combination based on the configuration of these sensors and the sensor inputs and coupling of the sensor inputs to the respective augmented sensors. Each augmented sensor may be implemented as a device that has at least a processor, a memory, and code stored in the memory where the code may relate to at least one algorithm that could be used to process the sensor inputs, for example, to generate some results. Each virtual master arbiter may provide control features with respect to the augmented sensors as described more in detail later. Centralized node 130 may refer to a host that may provide at least one service to a distributed information handling system such as LCDIHS 100. Such services may include a compute service, a storage service, or a networking service. Like cloud compute network 110, gateway 140 may include augmented sensor 146, augmented sensor 148, and augmented sensor 150. Each of the augmented sensors may perform similar analysis or operations on sensor input, for example sensor input 152. As shown in FIG. 1, sensor input may arise not only from external to gateway 140, but also from within gateway 140. As an example, sensor input 144 may relate to sensor data obtained from within the gateway. Sensor network 170 may similarly include augmented sensor 174. Sensor network 170 may further include the virtual master arbiter 172, and a centralized node 180. Sensor network 170 may further include the ability to receive sensor inputs, for example sensor input 176 and sensor input 178. Each one of the networks including cloud compute network 110, gateway 140, and sensor network 170 may include different combinations of augmented sensors, virtual master arbiters, and/or centralized nodes or other types of systems and devices, as needed. In each one of these networks, an augmented sensor may be a device that may provide the functionality of a sensor or may not. As an example, an augmented sensor may simply be a device that analyzes or processes inputs required by other sensors and does not perform any sensing operations. Instead, using certain algorithms, an augmented sensor may simply perform analytics on sensor inputs received via other sensors. Although FIG. 1 shows a certain number of components of LCDIHS 100 arranged in a certain manner, there could be more or fewer number of components arranged differently. As an example, LCDIHS 100 may include other networks, gateways, cloud/sensor networks and several other types of networks, including storage networks. As an example, there could be several hosts, devices, augmented sensors, and/or virtual master arbiters (and related controllers) as part of LCDIHS 100. In one example, there may be L hosts, M devices or augmented sensors, and O controllers, where each of L, M, and O is a positive integer.

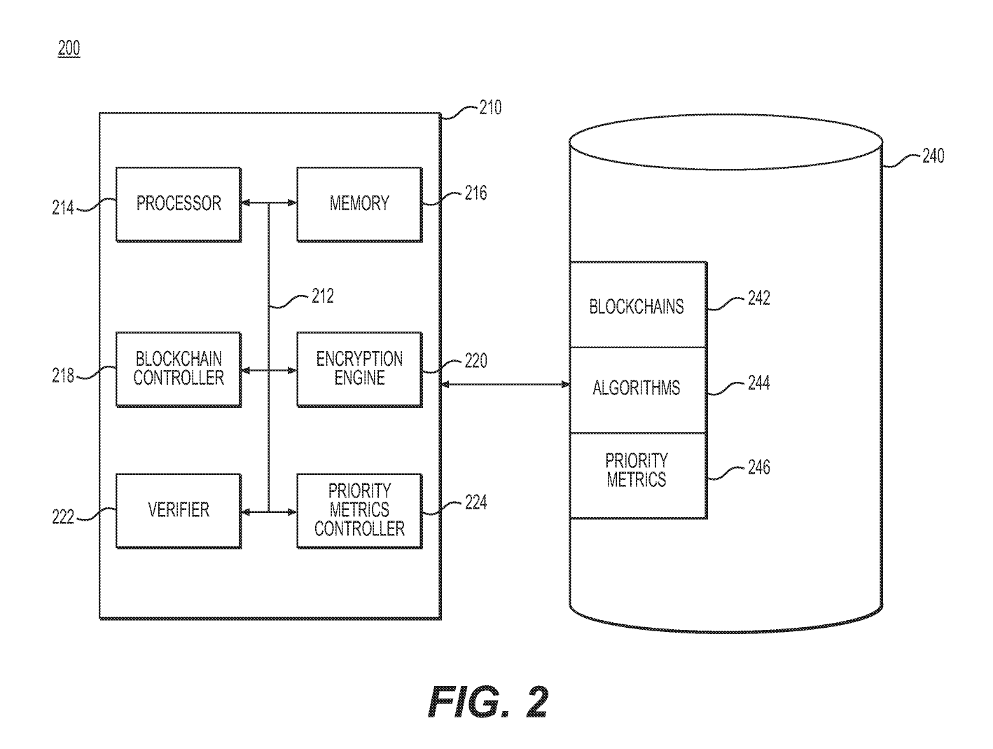

FIG. 2 is a block diagram of a virtual master arbiter 200 for a ledger-chained distributed information handling system 100 of FIG. 1 in accordance with one example. Virtual master arbiter 200 may include a controller 210 coupled to a database 240. Controller 210 may include a processor 214, a memory 216, a blockchain controller 218, an encryption engine 220, a verifier 222, and a priority metrics controller 224, each of which may be coupled to each other via at least one bus 212. Processor 214 may execute any algorithms or programs or code stored in memory 216 to enable at least some of the functionality associated with controller 210. In one example, blockchain controller 218 may be configured to manage blockchain 242 stored in database 240. Encryption engine 220 may be configured to create encrypted values or hash values corresponding to information processed by augmented sensors; for example, algorithms, transactions, or results. Encrypted values may be stored as part of blockchains 242. Verifier 222 may be configured to verify the blockchains or portions of the blockchains to determine whether a blockchain meets at least one condition before the blockchain is stored in database 240. Verifier 222 may perform operations, such as encryption or hash operations to convert any transactions related to updated algorithms into a string of digits, e.g., a hash value. Priority metrics controller 224 may allow a user or an administrator of the LCDIHS 100 to provide user specified criteria that may be used to modify the relative significance or priority of various inputs to an algorithm. In one example, priority metrics controller 224 may provide user specified information that may be stored in database 240 as priority metrics 246. Priority metrics controller 224 may access priority metrics 246 and process the information stored in priority metrics 246 to determine whether certain user specified criteria is met by an algorithm that is processing certain inputs to generate results.

With continued reference to FIG. 2, blockchain(s) may be replicated on tens or hundreds of virtual master arbiters. As described later, the blockchain(s) may be updated only when the relevant virtual master arbiters agree with each other through a consensus mechanism to update the blockchain in view of the various modifications to any of the algorithms. Although FIG. 2 shows a certain number of components of virtual master arbiter 200 arranged in a certain manner virtual master arbiter 200 may include additional or fewer components arranged differently. As an example, although FIG. 2 shows virtual master arbiter 200 as including a controller 210 and a database 240, the functionality associated with controller 210 and database 240 may be distributed or disaggregated in different ways. In addition, although FIG. 2 shows a certain number of components of controller 210 arranged in a certain manner there could be more or fewer components arranged differently. Similarly, although FIG. 2 shows a certain number of database tables stored in a database 240, there could be more or fewer number of database tables arranged differently. Additionally, the tables and/or other types of data structures stored in database 240 may be distributed or disaggregated in other types of databases or distributed databases.

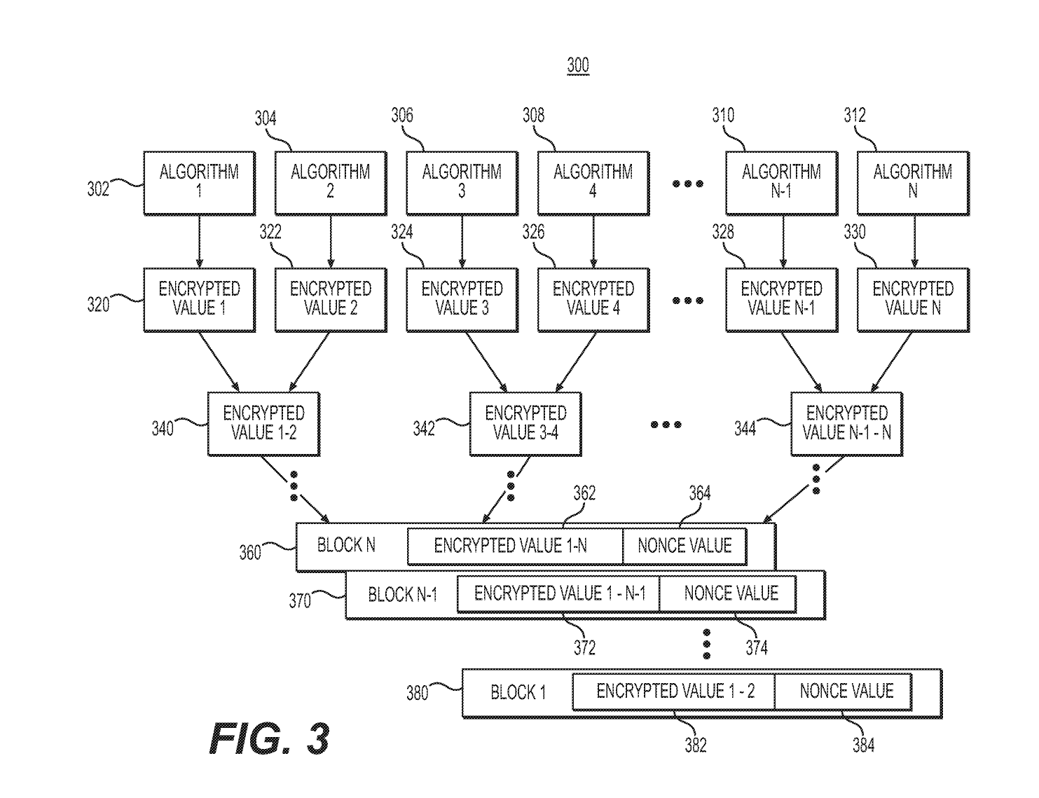

FIG. 3 is a diagram illustrating a portion of a ledger-chained distributed information handling system 100 in accordance with one example. As shown in FIG. 3, a ledger-chained mechanism may be used to distribute and manage changes to the various algorithms that may be stored on different middleware devices, including, for example, the various augmented sensors in cloud compute network 110, gateway 140, or sensor network 170. In this example, the ledger-chained mechanism is explained in relation to a blockchain based system. Algorithms 1-N (algorithm 1 302, algorithm 2 304, algorithm 3 306, algorithm 4 308, algorithm N−1 310, and algorithm N 312) may be processed by the ledger-chained mechanism to allow the distribution and management of updates to such algorithms in a distributed and a decentralized manner. In this example, prior to storage as part of the ledger, each one of the algorithms or a modification to an algorithm may be subjected to an encryption operation by using, for example, encryption engine 220 of FIG. 2, to generate a corresponding encrypted value. As an example, encrypted value 1 320 and encrypted value 2 322 may be generated that may correspond to algorithm 1 302 and algorithm 2 304, respectively. In one example, each encrypted value may be a hash value of a fixed length that may be obtained by applying a cryptographic or hash operation to any transactions relating to modifications to algorithms. Similarly, encrypted value 3 324 and encrypted value 4 326 may be generated that may correspond to algorithm 3 306 and algorithm 4 308, respectively. Additionally, encrypted value N−1 328 and encrypted value N 330 may be generated and those may correspond to algorithm N−1 310 and algorithm N 312, respectively. Next the encrypted values may be combined in a tree fashion, for example, by using a Merkle tree. Thus, encrypted value 1 320 and encrypted value 2 322 may be combined into encrypted value 1-2 340. Encrypted value 3 324 and encrypted value 4 326 may be combined into encrypted value 3-4 342. Similarly, encrypted value N−1 328 and encrypted value N 330 may be combined into encrypted value N−1-N 344. The combined encrypted values along with additional information may be stored in blocs corresponding to a blockchain. Blocks corresponding to a blockchain may be stored as part of blockchains 242 in database 240 of FIG. 2. Example block N 360, block N−1 370, and block 1 380 may be stored in blockchain(s) 242 in database 240. Each one of the blocks may include at least one ledger entry. Each ledger entry may include a header, which may include a hash value (e.g., an encrypted value) corresponding to each of the relevant transactions for the algorithms. Each of the blocks may further include nonce values or some other type of code to allow the blockchain controller, for example blockchain controller 218 of FIG. 2, to add additional information to the encrypted values for the respective algorithms. Example block N 360 may include encrypted value 1-N 362 and nonce value 364. Example block N−1 370 may include encrypted value 1-N−1 372 and nonce value 374. Example block 1 380 may include encrypted value 1-2 382 and nonce value 382. Each virtual master arbiter 200 may (by using verifier 222, for example) perform mathematical calculations to solve the cryptographic puzzle created by concatenating headers including hash values. Once a verifier comes up with a solution to the cryptographic puzzle, other verifiers in the LCDIHS 100 may confirm the validity of the solution. Without the solution to this puzzle, no blockchain header may be updated. In this example, to ensure the integrity of the system, virtual master arbiters may be required to be trusted controllers. Although FIG. 3 shows a certain way of processing information related to the algorithms to enable distributed updates and management of the algorithms, this information could be processed differently. As an example, the encrypted values may be combined differently.

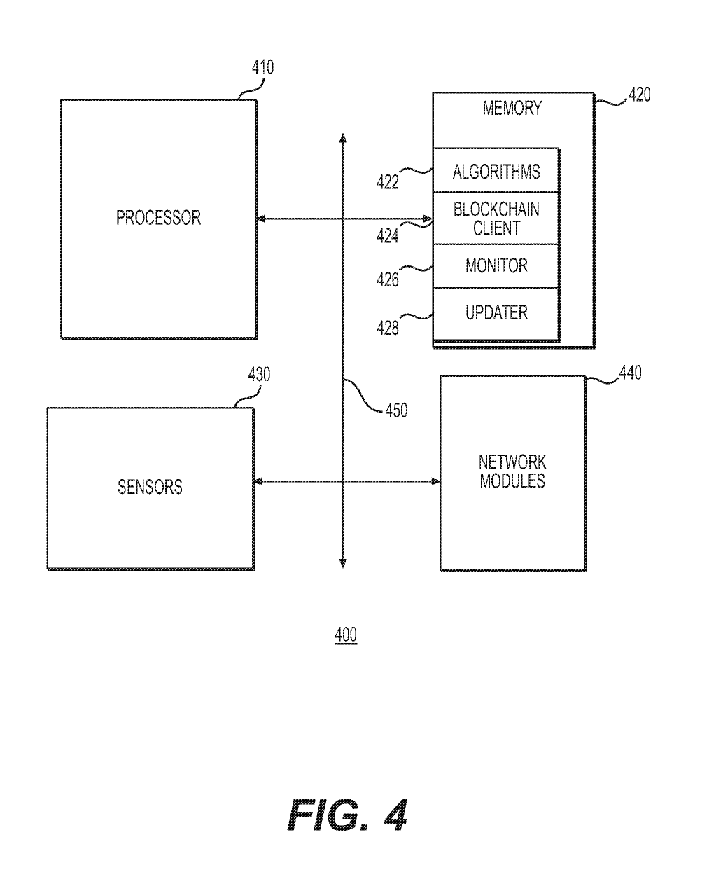

FIG. 4 is a diagram illustrating a device 400 for use in a ledger-chained distributed information handling system in accordance with one example. Device 400 may be configured as an augmented sensor or a different type of device to process certain inputs; for example, sensor inputs. In one example, device 400 may process the inputs to generate at least one result and the processing may be based on at least one algorithm. Device 400 may include a processor 410, a memory 420, sensors 430, and network modules 440. Each one of these components may be coupled using bus 450. Processor 410 may execute code corresponding to algorithms, an operating system, or other types of software. Processor 410 may be implemented using an off-the-shelf processor or using one or more Field-Programmable Gate Arrays (FPGAs), Application-Specific Integrated Circuits (ASICs), Application-Specific Standard Products (ASSPs), System-on-a-Chip systems (SOCs), or Complex Programmable Logic Devices (CPLDs). Memory 420 may include algorithms 422, a blockchain client 424, a monitor 426, and an updater 428. Memory 420 may be a combination of a volatile memory, such as DRAM, and a non-volatile memory, such as flash memory. Algorithms 422, stored in memory 420, may include at least one algorithm that may be executed or processed by processor 410. As an example, by executing any algorithms stored in memory 420, processor 410 may process various sensor inputs to provide at least one result. Blockchain client 424 may provide the functionality associated with the ability for device 400 to access blockchain controller 218 of FIG. 2 via an application program interface (API). Monitor 426 may provide the functionality associated with device 400 being able to detect any changes to any algorithms that device 400 may be processing. Updater 428 may provide the functionality associated with performing any updates needed for the algorithms, for example algorithms 422, that are being processed by device 400. Although not shown, each one of the various executable components stored in memory 420 may interact with an operating system that may be stored in memory 420 as well. Such interaction may occur via standard application program interfaces (APIs) or a custom API designed to allow the various components in memory 420 to exchange information and execute commands using the API. Sensors 430 may include different types of sensors. Sensors 430 may include various types of sensors for sensing physical conditions, chemical conditions, environmental conditions, network conditions or network performance, storage conditions or storage performance, compute conditions or compute performance, and other such sensors, including telemetry sensors. Network modules 440 may provide the functionality to device 400 of communicating with other components in the ledger-chained distributed information handling system. Network modules 440 may include network controllers for interfacing with various wired or wireless protocols, such as Wi-Fi, Ethernet, Bluetooth, or other such protocols. Although FIG. 4 shows a certain number of components of device 400 arranged in a certain manner device 400 may include additional or fewer components arranged differently. In addition, each device 400 may have a unique global identifier that may be used to track the devices. The global identifier may also be used to index information concerning the devices in any of the databases described with respect to FIG. 2.

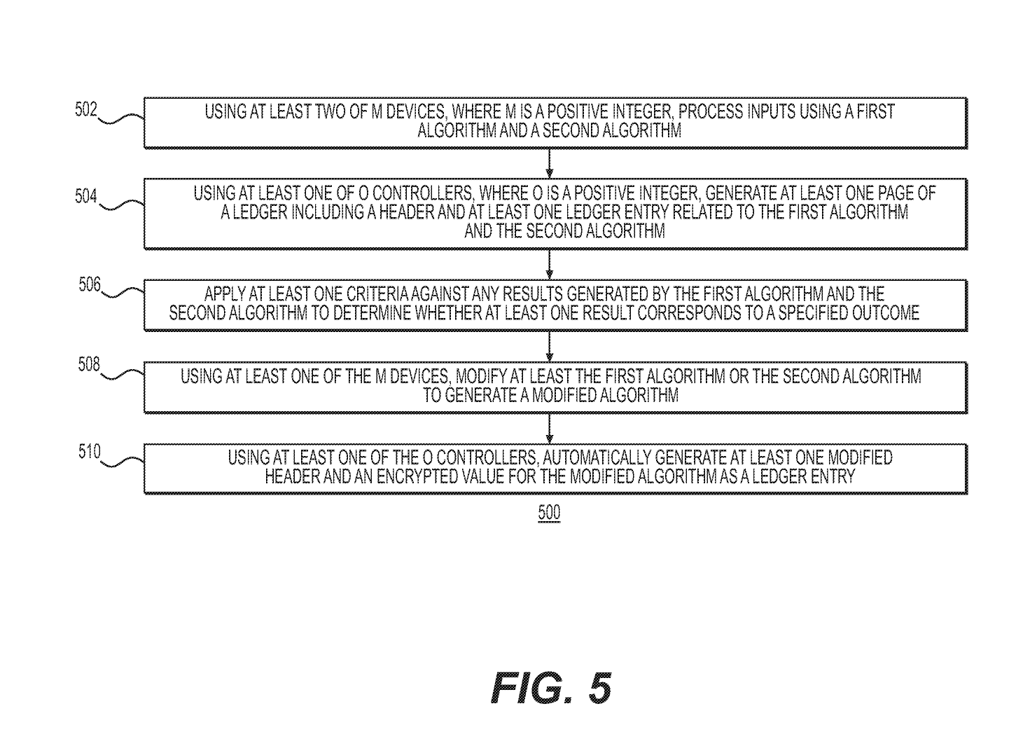

FIG. 5 is a diagram illustrating a method in a ledger-chained distributed information handling system in accordance with an example. In this example the method may be used with LCDIHS 100 described with respect to FIG. 1. In step 502, using at least two out of M devices (e.g., device 200 of FIG. 2), where M is a positive integer, one may process inputs (e.g., sensor inputs) using a first algorithm and/or a second algorithm. In this example the first algorithm may be the algorithm that was initially stored in the memory of a device. The second algorithm may be an algorithm that is going to replace the first algorithm. The second algorithm may also be an algorithm that is simply a modification of the first algorithm in that the second algorithm processes at least one different input from the first algorithm or it has at least one process, function, or code snippet that is different from the first algorithm. In step 504, using at least one of O controllers, where O is a positive integer, a controller corresponding to a virtual master arbiter 200 (e.g., controller 210 of FIG. 2) may generate at least one page of a ledger, including a header, and at least one ledger entry related to the first algorithm and/or the second algorithm. As part of this step, the virtual master arbiter may process the first algorithm or the second algorithm, transactions related to these algorithms, variables related to these algorithms, or inputs and/or outputs related to these algorithms. In this example, the page header may include an encrypted or hash value corresponding to the at least first algorithm or the second algorithm. The remaining part of the ledger entry may include a nonce value that may be added to the encrypted value as shown in, for example, FIG. 3.

In step 506, a controller corresponding to a virtual master arbiter (e.g., controller 210 of FIG. 2) may apply at least one criteria against any results generated by the first algorithm and/or the second algorithm to determine whether the at least one result corresponds to a specified outcome. As part of this step processor 214 and priority metrics controller 224 may cooperate with each other to evaluate priority metrics 246 stored in database 240 to determine, in real-time, whether a user specified criteria is satisfied by any of the results generated by either the first algorithm or the second algorithm. In this manner, a user, another system operator, or another entity, including even an automated piece of code may modify at least some part of the criteria stored as part of priority metrics 246 at any time in a distributed manner. At any time, a virtual master arbiter may process the priority metrics, for example using processor 214 and priority metrics controller 224, and that processing may result in determining whether the user specified criteria is being satisfied based on a particular outcome that the user may have required from an algorithm. The user specified criteria may provide a ranking or rating system to evaluate whether a particular outcome is satisfactory.

In step 508, using at least one of the M devices, the first algorithm or the second algorithm may be modified to generate a modified algorithm. As part of this step, a device (e.g., device 400 of FIG. 4) may modify the first algorithm or the second algorithm stored in the memory of the device to generate a modified algorithm. The modification of the algorithm may be made only if the at least one criteria when applied to the results corresponds to a specified outcome. In step 510, using at least one of the O controllers, one may automatically generate at least one modified header and an encrypted value for the modified algorithm as a ledger entry. This step may relate to generating a modified header which may be a one-way hash derived from the algorithm that has been modified or it may be an encrypted value for some other aspects of the modified algorithm. Although FIG. 5 shows the steps of method 500 being performed in a certain order, these steps may be performed in a different order and other steps may be added.

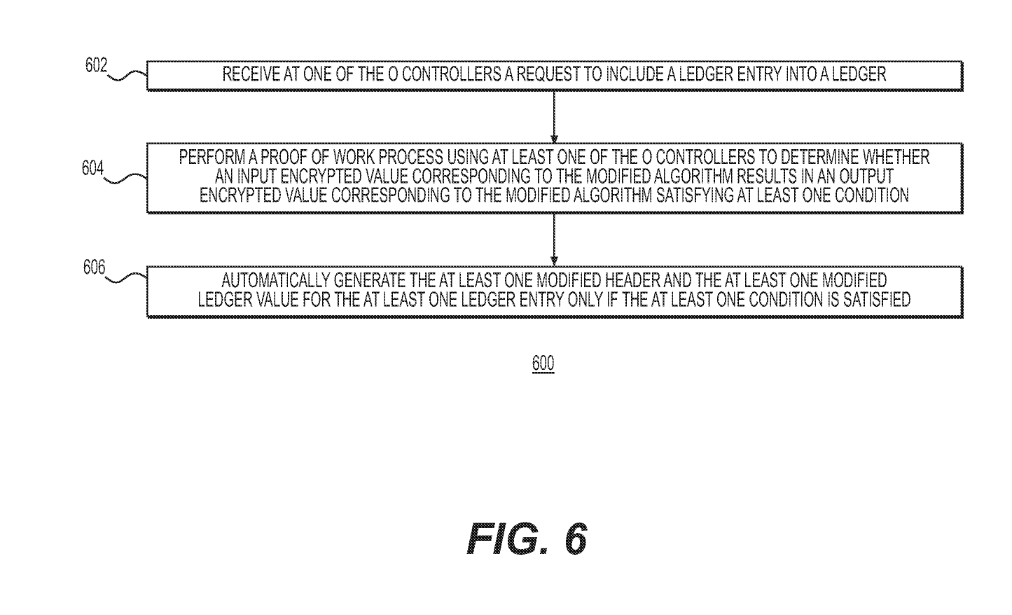

FIG. 6 is a diagram illustrating a method in a ledger-chained distributed information handling system in accordance with another example. In step 602, any one of the O controllers (e.g., virtual master arbiters 200) may receive a request to include a ledger entry into a ledger, such as blockchain(s) described earlier. This request may be generated in response to a modification to an algorithm by blockchain client 424 of FIG. 4. In step 604, at least one of the virtual master arbiters may perform a proof of work process to determine whether an input encrypted value corresponding to the modified algorithm results in an output encrypted value corresponding to the modified algorithm satisfying at least one condition. As described earlier, this process may include solving a cryptographic puzzle associated with a blockchain to find at least one solution. In this example, verifier 222 of FIG. 2 may modify the nonce value included as part of the blockchain being validated to determine the at least one solution. In step 606, blockchain controller 218 may automatically generate a new header and a modified ledger value (e.g., algorithm value) to at least one ledger entry (e.g., a block or a portion of a bock of a blockchain) only if the at least one condition is satisfied. Thus, once the solution to the cryptographic puzzle has been found by at least one blockchain controller then the other controllers may confirm the solution. In one example, a local copy or a portion of the blockchain may not be updated unless at least a pre-determined number of trusted blockchain controllers have confirmed the solution. Although FIG. 6 shows the steps of method 600 being performed in a certain order, these steps may be performed in a different order and other steps may be added.

It is to be understood that the methods, modules, and information handling systems depicted herein are merely exemplary. In general, although blockchain based systems are described as examples, other ledger-chained arrangements may be used. As an example, any mechanism that provides an ability to manage distributed updates to algorithms stored in middleware devices may be used. Alternatively, or in addition, the functionality described herein can be performed, at least in part, by one or more hardware logic components. For example, and without limitation, illustrative types of hardware logic components that can be used include Field-Programmable Gate Arrays (FPGAs), Application-Specific Integrated Circuits (ASICs), Application-Specific Standard Products (ASSPs), System-on-a-Chip systems (SOCs), Complex Programmable Logic Devices (CPLDs), etc. In an abstract, but still definite sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or inter-medial components. Likewise, any two components so associated can also be viewed as being “operably connected,” or “coupled,” to each other to achieve the desired functionality.

The functionality associated with the examples described in this disclosure can also include instructions stored in a non-transitory media. The term “non-transitory media” as used herein refers to any media storing data and/or instructions that cause a machine, such as processor 214 or processor 410, to operate in a specific manner. Exemplary non-transitory media include non-volatile media and/or volatile media. Non-volatile media include, for example, a hard disk, a solid state drive, a magnetic disk or tape, an optical disk or tape, a flash memory, an EPROM, NVRAM, PRAM, or other such media, or networked versions of such media. Volatile media include, for example, dynamic memory, such as DRAM, SRAM, a cache, or other such media. Non-transitory media is distinct from, but can be used in conjunction with, transmission media. Transmission media is used for transferring data and/or instruction to or from a machine, such as processor 214 or processor 410 that may be part of an information handling system. Exemplary transmission media include coaxial cables, fiber-optic cables, copper wires, and wireless media, such as radio waves.

Furthermore, those skilled in the art will recognize that boundaries between the functionality of the above described operations are merely illustrative. The functionality of multiple operations may be combined into a single operation, and/or the functionality of a single operation may be distributed in additional operations. Moreover, alternative embodiments may include multiple instances of a particular operation, and the order of operations may be altered in various other embodiments.

Although the disclosure provides specific examples, various modifications and changes can be made without departing from the scope of the disclosure as set forth in the claims below. Accordingly, the specification and figures are to be regarded in an illustrative rather than a restrictive sense, and all such modifications are intended to be included within the scope of the present invention. Any benefits, advantages, or solutions to problems that are described herein with regard to a specific example are not intended to be construed as a critical, required, or essential feature or element of any or all the claims.

Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles.

Unless stated otherwise, terms such as “first” and “second” are used to arbitrarily distinguish between the elements such terms describe. Thus, these terms are not necessarily intended to indicate temporal or other prioritization of such elements. In addition, as used herein, the term “in response” is not limited to a direct and an immediate action based on another action. Instead, this term includes actions that may occur as part of a sequence of operations in which only a subset of the actions, such as a first action, may occur based on another action and the later actions may occur because they may be required to complete a method or that may be part of a sequence of actions that flow from the first action.

What is claimed:

1. An information handling system (IHS) comprising:
M augmented sensors, wherein M is a positive integer, and wherein each of the M augmented sensors is configured to process at least a plurality of inputs using at least one algorithm from a set of N algorithms, wherein N is a positive integer, and wherein each of the N algorithms is configured to process a plurality of inputs to generate at least one result; and
O controllers, wherein O is a positive integer, and wherein each of the O controllers is configured to process at least one of a subset of the N algorithms or a subset of at least N results to generate at least one entry for a ledger comprising at least one header and at least one ledger value corresponding to the at least one of the subset of the N algorithms or the subset of the at least N results, wherein each of the M augmented sensors is further configured to without any direct input from any of L hosts, wherein L is a positive integer, and wherein each of the L hosts is configured to provide at least one service to the IHS, automatically modify at least one of the N algorithms to generate a modified algorithm, wherein the modified algorithm comprises at least one of a modified code for the least one of the N algorithms or at least one modified input for the at least one of the N algorithms, and wherein each of a subset of the O controllers is further configured to, based on at least the modified algorithm, automatically generate at least one modified header and at least one modified ledger value for at least one ledger entry.

2. The IHS of claim 1, wherein each of the subset of the O controllers is further configured to apply at least one criteria against any results generated by the modified algorithm to determine whether at least one result corresponds to a specified outcome based on the at least one criteria.

3. The IHS of claim 2, wherein each of the M augmented sensors is further configured to automatically modify the at least one of the N algorithms in response to receiving an indication from at least one of the subset of the O controllers that the at least one result corresponds to the specified outcome.

4. The IHS of claim 1, wherein the ledger comprises a blockchain, and wherein the at least one ledger entry comprises at least a portion of a block corresponding to the blockchain.

5. The IHS of claim 1, wherein each of the subset of the O controllers is further configured to perform a proof of work process to determine whether an input encrypted value corresponding to the modified algorithm results in an output encrypted value corresponding to the modified algorithm satisfying at least one condition.

6. The IHS of claim 5, wherein each of the subset of the O controllers is further configured to automatically generate the at least one modified header and the at least one modified ledger value for the at least one ledger entry only if the at least one condition is satisfied.

7. A method in an information handling system (IHS) comprising: (1) M devices, wherein M is a positive integer, and wherein each of the M devices is configured to process at least a plurality of inputs using at least one algorithm from a set of N algorithms, wherein N is a positive integer, and wherein each of the N algorithms is configured to process a plurality of inputs to generate at least one result, and (2) O controllers, wherein O is a positive integer, and wherein each of the O controllers is configured to process at least one of a subset of the N algorithms or a subset of at least N results to generate at least one header and at least one ledger value for at least one ledger entry corresponding to the at least one of the subset of the N algorithms or the subset of the at least N results, the method comprising:
without any direct input from any of L hosts, wherein L is a positive integer, and wherein each of the L hosts is configured to provide at least one service to the IHS, automatically modifying at least one of the N algorithms to generate a modified algorithm, wherein the modified algorithm comprises at least one of a modified code for the least one of the N algorithms or at least one modified input for the at least one of the N algorithms; and
providing the modified algorithm to a subset of the O controllers.

8. The method of claim 7 further comprising the subset of the O controllers applying at least one criteria against any result generated by the modified algorithm to determine whether the result corresponds to a specified outcome based on the at least one criteria.

9. The method of claim 8 further comprising each of the M devices automatically modifying the at least one of the N algorithms in response to receiving an indication from at least one of the subset of the O controllers that the result corresponds to the specified outcome.

10. The method of claim 7, wherein the ledger comprises a blockchain, and wherein the at least one ledger entry comprises at least a portion of a block corresponding to the blockchain.

11. The method of claim 9 further comprising the subset of the O controllers performing a proof of work process to determine whether an input encrypted value corresponding to the modified algorithm results in an output encrypted value corresponding to the modified algorithm satisfying at least one condition.

12. The method of claim 11 further comprising automatically generating at least one modified header and at least one modified ledger value for the at least one ledger entry only if the at least one condition is satisfied.

13. An information handling system (IHS) comprising:
M devices, wherein M is a positive integer, and wherein each of the M devices is configured to process at least a plurality of inputs using at least one algorithm from a set of N algorithms, wherein N is a positive integer, and wherein each of the N algorithms is configured to process a plurality of inputs to generate at least one result; and
O controllers, wherein O is a positive integer, and wherein each of the O controllers is configured to generate at least one entry for a ledger comprising at least one header and at least one ledger value corresponding to the at least one of the subset of the N algorithms or the subset of the at least N results, wherein each of the M devices is further configured to automatically modify at least one of the N algorithms to generate a modified algorithm, wherein the modified algorithm comprises at least one of a modified code for the at least one of the N algorithms or at least one modified input for the at least one of the N algorithms, and wherein each of a subset of the O controllers is further configured to, based on at least the modified algorithm, automatically generate at least one modified header and at least one modified ledger value for at least one ledger entry.

14. The IHS of claim 13, wherein each of the subset of the O controllers is further configured to apply at least one criteria against any result generated by each of the M devices to determine at least one result corresponding to a specified outcome based on the at least one criteria.

15. The IHS of claim 14, wherein each of the M devices is further configured to automatically modify the at least one of the N algorithms in response to receiving an indication from at least one of the subset of the O controllers that the at least one result corresponds to the specified outcome.

16. The IHS of claim 13, wherein the ledger comprises a blockchain, and wherein the at least one ledger entry comprises at least a portion of a block corresponding to the blockchain.

17. The IHS of claim 13, wherein each of the M devices is further configured to, without any direct input from any of L hosts, wherein L is a positive integer, and wherein each of the L hosts is configured to provide at least one service to the HIS, automatically modify the at least one of the N algorithms to generate the modified algorithm.

18. The IHS of claim 13, wherein each of the subset of the O controllers is further configured to perform a proof of work process to determine whether an input encrypted value corresponding to the modified algorithm results in an output encrypted value corresponding to the modified algorithm satisfying at least one condition.

19. The IHS of claim 18, wherein each of the subset of the O controllers is further configured to automatically generate the at least one modified header and the at least one modified ledger value for the at least one ledger entry only if the at least one condition is satisfied.

20. The IHS of claim 13, wherein the ledger comprises a database indexed by a device identifier associated with each of the M devices.
